(19) United States
(12) Patent Application Publication
(10) Pub. No.: US 2024/0278876 A1
(43) Pub. Date: Aug. 22, 2024

(54) Mooring System for a Floating Wind Turbine

(71) Applicant: Aerodyn Consulting Singapore PTE LTD, Singapore (SG)

(72) Inventor: Sönke SIEGFRIEDSEN, Rendsburg (DE)

(73) Assignee: Aerodyn Consulting Singapore PTE LTD, Singapore (SG)

(21) Appl. No.: 18/570,475

(22) PCT Filed: Jul. 21, 2022
(86) PCT No.: PCT/IB2022/056744

§ 371 Date: Dec. 14, 2023

(30) Foreign Application Priority Data
Sep. 6, 2021 (DE) 102021123006.3

(51) Int. Cl. B63B 21/20; B63B 21/00; B63B 21/50; B63B 27/00; F03D 13/25

(52) U.S. Cl. CPC B63B 21/20; B63B 21/50; B63B 27/00; F03D 13/256; B63B 2021/003; B63B 2021/203; B63B 2213/02; F05B 2240/93

(57) ABSTRACT

The invention relates to a system comprising: a foundation element that has a universal joint, wherein the universal joint has a first universal joint element connected to the foundation element for conjoint rotation and a second universal joint element which is rotatable about the longitudinal axis of the first universal joint element by carrying out a rotation about its own longitudinal axis; a floating wind turbine; and a mooring line. One end of mooring line is connected to the foundation element a first connector connected to the second universal joint element for conjoint rotation and the other end of which is connected to the floating wind turbine a second connector rotatably mounted on the floating wind turbine. The system also includes a controller which, on the basis of the rotational position of the floating wind turbine about the foundation element, brings about the adoption of a rotational position of the second connector rotatably mounted on the floating wind turbine; wherein the rotational position of the second connector rotatably mounted on the floating wind turbine corresponds to the rotational position of the second universal joint element about its own longitudinal axis, which rotational position geometrically corresponds to the rotational position of the floating wind turbine about the foundation element.

The invention relates to a mooring system for anchoring a floating wind turbine to a bed of body of water. In particular, the invention relates to a system comprising a foundation element that has a universal joint, wherein the universal joint has a first axle stub connected to the foundation element in a rotationally fixed manner and a second axle stub which is rotatable about the longitudinal axis of the first axle stub by carrying out a rotation about its own longitudinal axis; a floating wind turbine; and a mooring line, one end of which is connected to the foundation element by means of a first connection means connected to the second axle stub in a rotationally fixed manner, and the other end of which is connected to the floating wind turbine by means of a second connection means rotatably mounted on the floating wind turbine.

Such a system is known in particular from DE 10 2004 056 401 A. This discloses a self-aligning floating wind turbine designed as a leeward runner which is fastened to the bed of the body of water by means of only a single mooring line at a single anchor point. The mooring line is connected to the foundation element by means of a first universal joint and to the single-point mooring wind turbine by means of a second universal joint, wherein the upper end of the mooring line is also to be rotatably mounted on the wind turbine.

Furthermore, a single-point mooring wind turbine is known from DE 10 2013 111 115 B3 in which the coupling between the mooring line and the floating wind turbine comprises a slip coupling and a vortex coupling which can be separately or jointly gimbaled.

The known wind turbines have a partially quite complex structure which is difficult to realize so that the object of the present invention is to further develop the system comprising a foundation element, a floating wind turbine, and a mooring line connecting the foundation element to the floating wind turbine so that it is constructed as simple as possible and can be installed and maintained efficiently.

According to the invention, this object is achieved by the system with the features of claim 1. The dependent claims reflect advantageous embodiments of the invention.

The basic idea of the invention consists of anchoring a floating wind turbine to only a single fastening point or foundation element by means of a mooring line on the bed of the body of water so that the floating wind turbine can orient itself depending on the wind direction like a ship lying at anchor. This means that only a single connection exists between a foundation element on the bed of the body of water and the floating wind turbine. For this purpose, the foundation element on the bed of the body of water must not only be designed for absorbing horizontal forces, but also for absorbing vertical loads.

For this purpose, pile foundations or suction bucket foundations at greater water depths are also suitable for this purpose. The type of connection of the foundation element to the bed of the body of water can, however, also be redundantly designed for safety reasons.

To prevent the mooring line from winding around itself during the inevitable rotation of the entire floating wind turbine around the foundation element on the bed of the body of water, a suitable device exists to actively counteract this twisting. According to the invention, this is achieved by arranging a cardanic but torsionally rigid suspension on the foundation element, which always aligns the mooring line from the foundation element in the direction of the floating wind turbine without winding around itself. In order to prevent rotation of the mooring lines during rotation of the floating wind turbine around the foundation element, the mooring line is simultaneously also rotated about its own longitudinal axis on the floating wind turbine.

The cardanic suspension is realized by a conventional universal joint with intersecting joint rotary axes or an eccentric universal joint. A conventional universal joint allows bending angles of not more than 35-45°, whereas eccentric universal joints allow a bending angle of up to 90°.

A rotary drive is preferably located on the floating wind turbine and can rotate a slewing gear having a thrust bearing, to which the connecting means connecting the mooring line to the wind turbine is attached. The rotary drive is controlled via a sensor system which determines the current position and preferably also the alignment of the floating wind turbine with respect to the foundation element.

For redundancy reasons, the connection between the foundation element on the bed of the body of water and the floating wind turbine can preferably consist of two independent, parallel mooring lines. The mooring lines are preferably synthetic lines which particularly preferably have a specific weight of about 1000 kg/m³ and in principle have a certain elasticity for dampening as far as possible the dynamic forces on the floating wind turbine under wind and wave loads. Most preferably, two mooring line are guided in parallel and doubled so that the load is distributed substantially uniformly on four cables. The mooring lines are preferably designed in two parts, wherein the ends of these mooring lines are most preferably fastened to a connector designed as a buoy which is located close to the floating wind turbine. In this case, the sections of the mooring lines are each placed on the foundation element on the bed of the body of water by a block or an idler pulley and guided back upward to the connector. The connection is made with two mooring lines in parallel to have redundancy in case of failure of one mooring line. This design makes it possible to replace a mooring line without having to perform work on the bed of the body of water with divers or submarines.

The length of the section of the mooring line between the foundation element and the connector should be sensibly selected such that the connector, which has been uncoupled from the wind turbine, can surface and float on the surface of the water and, particularly preferably, can also be lifted a few meters out of the water in order to be able to perform maintenance work, e.g., the replacement of a mooring line, on a ship. On the other hand, the connection should also not be too long to keep the mooring lines from lying on the bed of the body of water.

If the mooring line is designed in two sections and the two sections are connected to one another by a connector, further connecting means are provided on the underside of the connector facing the foundation element and on the upper side of the connector facing away from the foundation element for connecting the sections of the mooring lines to the connector. These further connecting means are preferably provided redundantly in each case, especially preferably twice. However, the length of the section between the connector and the wind turbine is designed shorter than the length of the section between the foundation element and the connector. Both sections of the mooring lines can consist of synthetic cables or steel cables. In any case, the mooring line sections are detachably connected to the connector.

In principle, it is provided that a power cable connecting the wind turbine to the electrical grid is also routed parallel to the mooring lines, preferably between them. The electrical connection at the connector can be released in order to release the floating wind turbine from the mooring system, for example in order to tow the floating wind turbine into a harbor for repair or maintenance.

In this state, the connector designed as a buoy floats on the surface of the water so that a reconnection to the floating wind turbine can easily be carried out above the water's surface after the repair is complete. The power cable is preferably routed centrally through the universal joint on the foundation element on the bed of the body of water and out through the foundation element and connected to the outgoing submarine cable. The power cable from the floating wind turbine to the foundation element must have a certain material elasticity or geometric resilience in order to be able to follow the movements of the mooring lines and not build up any unacceptably large mechanical residual stresses. On the side of the floating wind turbine, the power cable is run centrally through the thrust bearing. Accordingly, when the alignment of the floating wind turbine changes due to a change in wind direction, the rotary drive also turns to compensate for the connection twist, then the power cable twists on the opposite side of the thrust bearing from the mooring line inside the wind turbine. To untwist the power cable when a still permissible limit value of the twist is reached, the floating wind turbine is then disconnected from the grid with the aid of the medium-voltage switchgear and a twisted power cable is untwisted, in particular by means of the electrical coupling known from DE 10 2017 119 635 B3.

The rotary drive for compensating for a possible twisting of the mooring line (and the power cable) between the foundation element and the floating wind turbine is controlled, for example, by a compass which determines the alignment of the floating wind turbine relative to the foundation element on the bed of the body of water. Since a universal joint does not represent a homokinetic joint, the relationship between the angle of rotation of the pivoted axis of the joint and the angle of rotation about the perpendicular axis of the other side of the joint is not linear, but is subject to an angular function which is dependent on the bending angle of the universal joint. If a simple joint is bent by the bending angle ß and rotated in this state, the angle (φ₂ (i.e., the rotation angle of the second axle stub) of the axle stub configured for connection to the connecting means deviates from the angle (φ₁ (i.e., the rotation position of the second axle stub) of the axle stub connected to the foundation element in a rotationally fixed manner. Between the angles, the relationship exists:

$$φ 2 = arctan ( \frac{tan φ 1}{cos β} )$$

In addition, for the rare situation where there is no wind, current or wave, it is preferred to ensure that the distance between the foundation element and the floating wind turbine does not fall below a minimum to prevent the mooring line from lying on the bed of the body of water or twisting a loose mooring line. This is preferably accomplished by detecting the current position of the floating wind turbine relative to the position of the foundation element, for example by means of a satellite-based positioning system, and when the distance falls below a predetermined minimum distance, i.e., slack exists, a drive, in particular a ship's drive, is activated which propels the wind turbine away from the position of the foundation element and keeps the mooring line slightly taut. The drive, which is preferably electrically driven, can be designed as a propeller or in the manner of a transverse jet control system. As an alternative to using a satellite-based positioning system, the tensile stress of the connecting means can also be detected and appropriate propulsion initiated when the tensile stress falls below a predetermined level.

According to the invention, a system is therefore proposed comprising a foundation element that has a universal joint, wherein the universal joint has a first axle stub connected to the foundation element in a rotationally fixed manner and a second axle stub which is rotatable about the longitudinal axis of the first axle stub by carrying out a rotation about its own longitudinal axis; a floating wind turbine; and a mooring line, one end of which is connected to the foundation element by means of a first connection means connected to the second axle stub in a rotationally fixed manner, and the other end of which is connected to the floating wind turbine by means of a second connection means rotatably mounted on the floating wind turbine, wherein a controller is provided which causes the assumption of a rotational position of the second connecting means rotatably mounted on the floating wind energy plant in dependence on the rotational position of the floating wind turbine about the foundation element, wherein the rotational position of the second connecting means rotatably mounted on the floating wind turbine corresponds to the rotational position of the second axle stub about its own longitudinal axis, which corresponds geometrically to the rotational position of the floating wind turbine about the foundation element. In other words, the second axle stub and the second connection means are always aligned identically to one another in their rotational position so that the mooring lines cannot twist.

Preferably, the controller is configured taking into account the alignment of the longitudinal axis of the floating wind turbine relative to the foundation element to cause the assumption of the rotational position of the second connecting means rotatably mounted on the floating wind turbine. For this purpose, the controller particularly preferably has a compass for determining the alignment of the longitudinal axis of the floating wind turbine relative to the foundation element.

The controller further preferably has a sensor for positioning by means of a global satellite navigation system.

The controller preferably comprises a rotary drive for rotating the rotatably mounted second connecting means. The rotary drive is in particular electrically driven and is configured for unlimited rotation of the second connecting means in both directions of rotation. In particular, the rotary drive has a sensor for detecting the rotational position of the second connecting means relative to the wind turbine so that the controller can switch off the rotary drive when a target rotational position is specified when this rotational position detected by the sensor is reached.

Furthermore, it is preferably provided that the floating wind turbine has an electrical coupling for connecting to a power cable connected to an electrical grid arranged outside the wind turbine and having a first electrical plug connector connected to the power cable and having a second electrical connector complementary to the first electrical connector and connected to an electrical grid located within the wind turbine, wherein the plug connectors are movable relative to one another for forming and disconnecting an electrical plug connection and are configured so as to be rotatable relative to one another in order to disentangle the power cable connected to the first plug connector. This electrical coupling has, in particular, the features of the electrical coupling known from DE 102017 119 635 B3 which are included in this application by way of reference.

According to another preferred embodiment, it is provided that the controller has a drive holding the floating wind turbine to a predetermined distance from the foundation element, in particular a ship drive.

The foundation element is preferably a pile foundation, a suction bucket foundation or a heavyweight foundation, wherein the universal joint connected to the foundation element can be a conventional universal joint with intersecting joint rotary axes or an eccentric universal joint.

In any case, it is preferably provided that the universal joint is enclosed by a bellows protecting the universal joint, which follows the movements of the universal joint and is specifically made of stainless steel. This bellows is preferably filled with grease for lubricating the universal joint and for protection against corrosion or for protection against the sea water and fouling, and most preferably has a restoring force forcing the axle stubs of the universal joint into a extended arrangement. A conventional universal joint is used in particular when a bending angle of approximately 35° to 45° is sufficient at the location of the installation of the floating wind turbine. Should a greater bending angle be required due to the local conditions, an eccentric universal joint is preferably used which allows a bending angle up to 90°.

Furthermore, it is preferably provided that the foundation element has a connection configured for connection to a power cable. This embodiment enables a simple prefabricated construction which simplifies the additional work to connect the floating wind turbine to the electrical grid.

The connection is specifically designed as a plug connector which can be connected or is connected to a power cable which is in electrical connection to an electrical grid arranged outside the wind turbine. Alternatively, the connection can be provided as a bushing accommodating a cable connected to an electrical grid located outside the wind turbine, through which a power line connecting the floating wind turbine to the electrical grid is led and secured if necessary.

In any case, however, the universal joint has a bushing which accommodates a power cable connected to an electrical grid arranged outside the wind turbine. In this case, the bushing is arranged centrally in the axle stubs forming the universal joint and the intermediate piece connecting the axle stubs to one another. This therefore always ensures that the bending angle and alignment of the universal joint is identical to the bending angle and alignment of the power cable.

The first connecting means and/or the second connecting means is preferably a pulley about which the mooring line is guided. Particularly preferably, another connecting means arranged parallel to the first connecting means and to the second connecting means and designed as a pulley is provided in each case to guide another mooring line. The redundant design of the particularly preferred connection of the foundation element to the floating wind turbine therefore ensures that the turbine continues to be held securely in the event that a mooring line breaks. Overall, the tensile load of two mooring lines, each guided around a pulley, is therefore distributed substantially functionally evenly over four cables so that the diameter of the mooring lines can be selected to be relatively small and thereby save weight. The use of an idler pulley on the foundation element has the advantage that, in the event that a mooring line needs to be replaced, for example due to wear of a mooring line or prescribed by a certifier at predetermined time intervals, work can be performed on the surface of the water without the use of divers or submarines. For this purpose, the upper end of a mooring line is connected to a new mooring line, and the entire mooring line is completely pulled through so that the old mooring line is removed and the new mooring line is installed.

The mooring line is designed especially in two parts, wherein the two sections of the mooring line are connected to one another by means of a connector. The connector in turn is preferably designed as a buoyant buoy. This most preferably has on one of its surfaces a first connection for a first power cable connecting the connector to an electrical grid arranged outside the wind turbine and, on a surface opposite this surface, a second connection for a second power cable connecting the connector to the floating wind turbine. This embodiment makes it possible to make the connection between the sections of the mooring line and accordingly the connection of the wind turbine to the foundation element on the surface of the body of water.

In this case, the length of the section connecting the foundation element to the connector corresponds to at least the depth of water in the region of the foundation element.

Finally, the mooring line is preferably a cable, in particular a synthetic cable or a steel cable.

The invention is explained in greater detail below with reference to a particularly preferred embodiment shown in the attached drawings, in which:

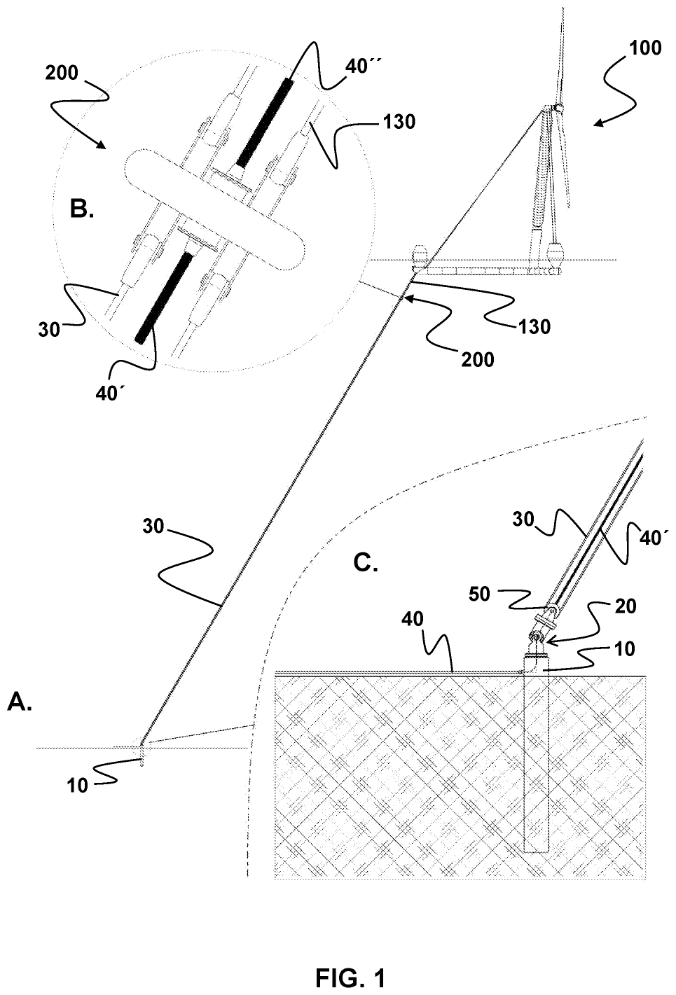

FIG. 1 shows an overview of a particularly preferably designed system according to the invention with a particularly preferably designed floating wind turbine (A) anchored to the bottom of a body of water by means of a foundation element, a detailed view of a particularly preferably designed connector (B) connecting the mooring lines attached to the foundation to the wind turbine, and a detail view of the foundation element (C) anchored in the bottom of the body of water;

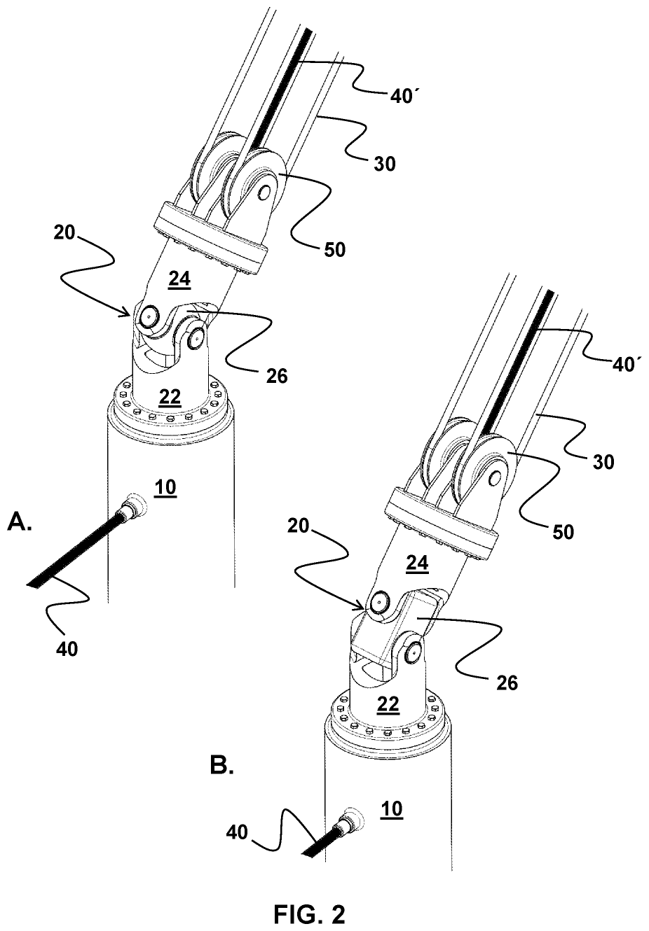

FIG. 2 shows a perspective view of a particularly preferably configured foundation element with a conventional universal joint with intersecting joint rotary axes (A) and with an eccentric universal joint (B);

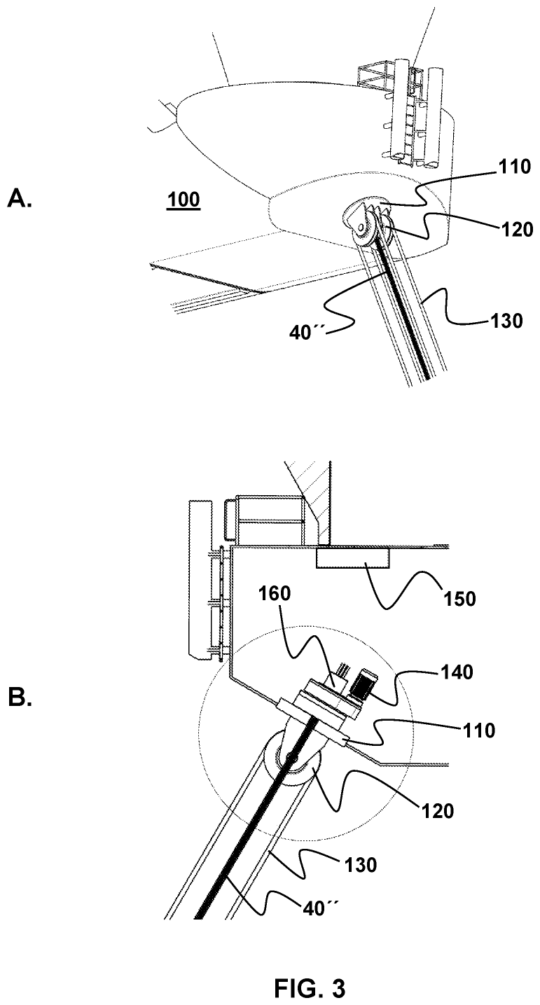

FIG. 3 shows the connection of the mooring lines connected to the foundation element to the floating wind turbine in a perspective view (A) and in a sectional view (B);

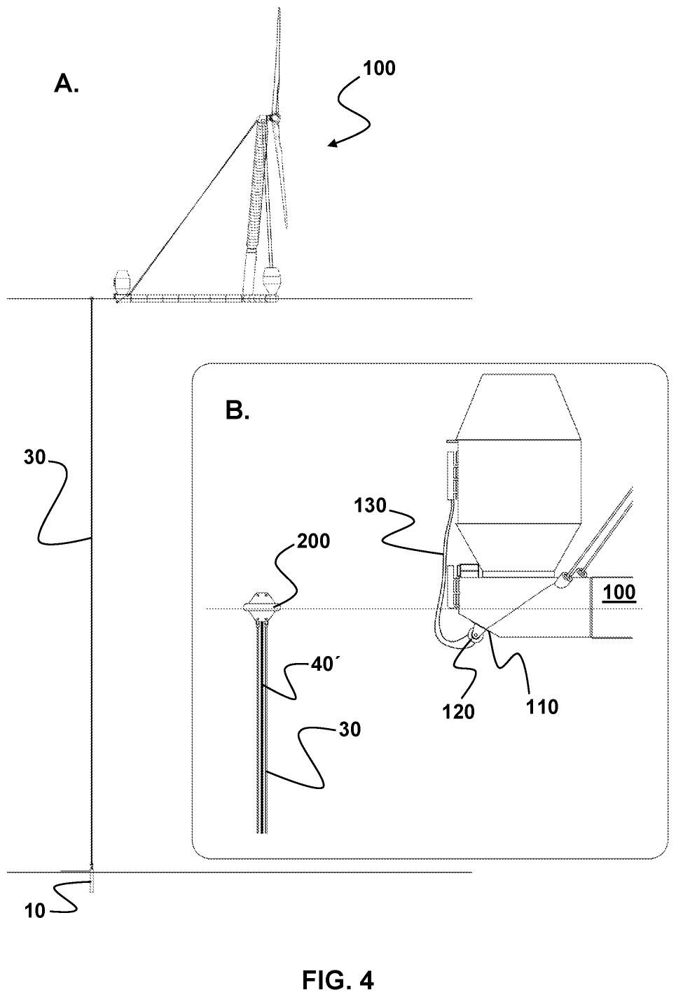

FIG. 4 shows a particularly preferably designed floating wind turbine before the anchoring thereof to the bed of the body of water in an overview (A) and in a detail view in the region of the surface of the body of water (B);

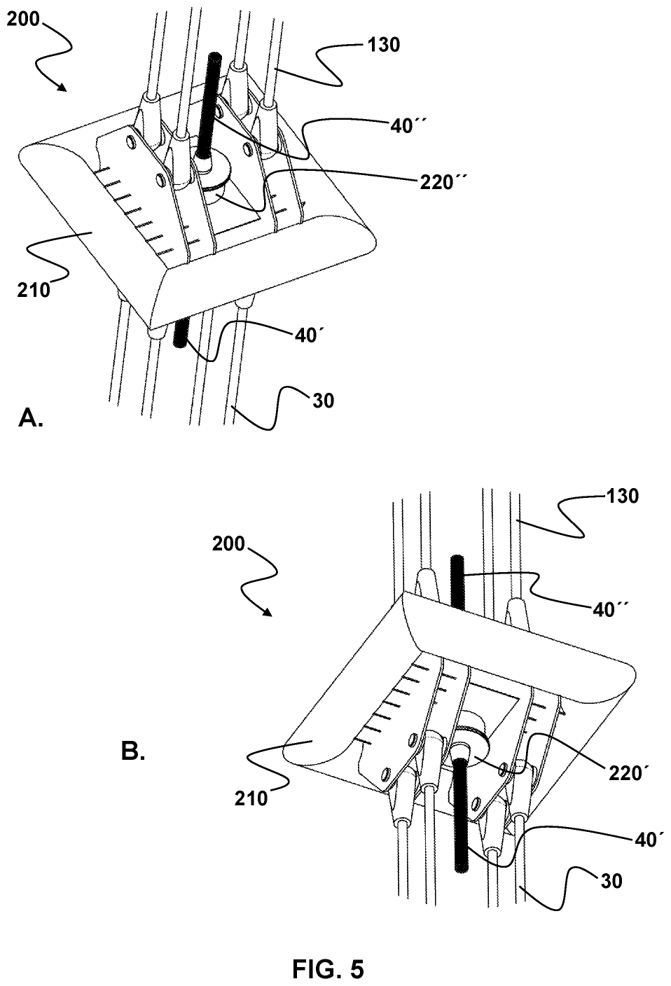

FIG. 5 shows the connector shown in FIG. 4B and connecting the foundation element to the floating wind turbine in a perspective view from above (A) and from below (B);

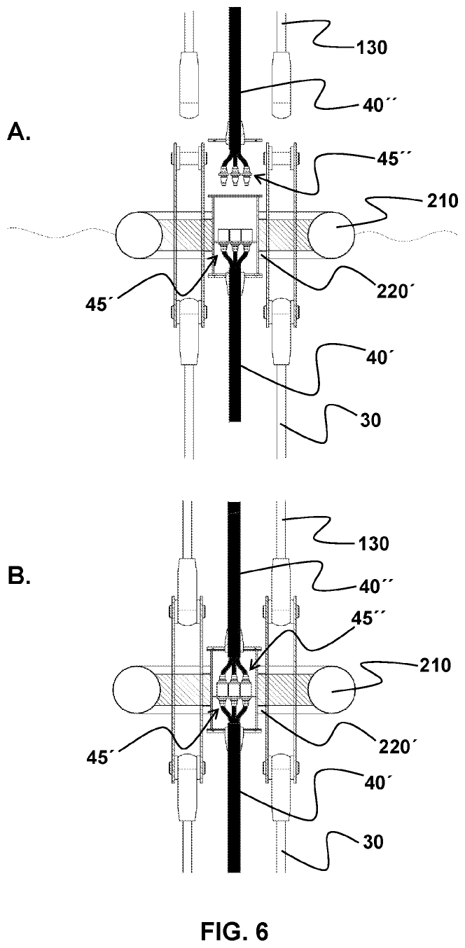

FIG. 6 shows a sectional view of the connector in the decoupled state (A) and in the coupled state (B);

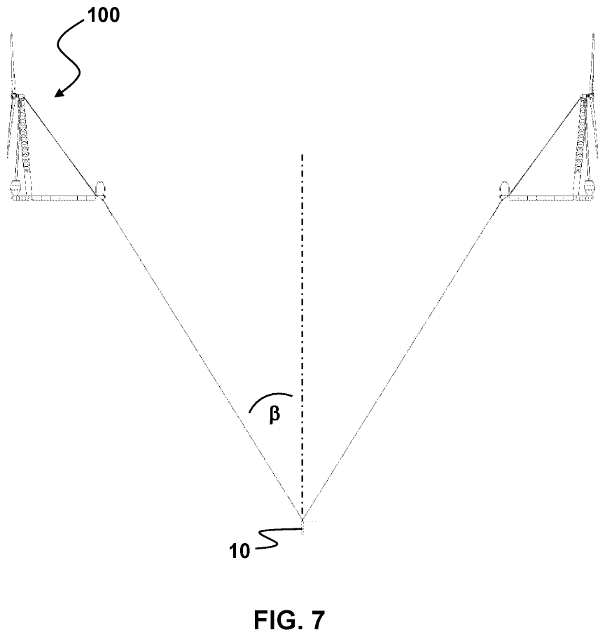

FIG. 7 shows a side view of the floating wind turbine anchored on the bed of the body of water in two positions caused by different wind directions; and

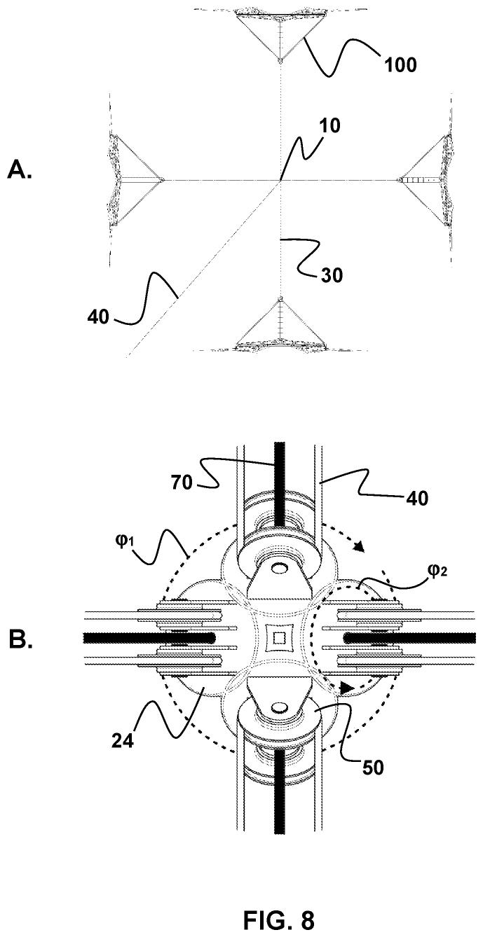

FIG. 8 shows a plan view of the floating wind turbine in four positions caused by different wind directions.

FIG. 1 shows an overview of a particularly preferably designed system according to the invention with a particularly preferably designed floating wind turbine (A) anchored to the bottom of a body of water by means of a foundation element, a detailed view of a particularly preferably designed connector (B) connecting the mooring lines attached to the foundation to the wind turbine, and a detail view of the foundation element (C) anchored in the bottom of the body of water. In particular, FIG. 1A shows a floating wind turbine 100 that is anchored to a bed of a body of water by means of the foundation element 10 and which is oriented into the wind during operation and clamps the mooring line 30 connecting to the foundation element 10. FIG. 4C shows in this regard a detail view of the foundation element 10 anchored in the bed of the body of water. During operation of the floating wind turbine 100, the angle assumed by the mooring line 30 relative to the bottom of the body of water is substantially the same as the angle assumed between the mooring line routed between the connection of the mooring line 30 to the wind turbine 100 and the tower of the floating wind turbine 100 and the foundation of the floating wind turbine 100.

As a special feature of this exemplary embodiment, the first section of the mooring line 30 connected to the foundation element 10 is not directly connected to the wind turbine 100, but to a connector 200 designed as a buoy. As FIG. 4B shows in a detail view, the connection of the first section of the mooring line 30 to the floating wind turbine 100 takes place indirectly via the connector 200 which is connected to the second section of the mooring line 130 connected to the floating wind turbine 100. It is also provided that the power cable 40′ leading to the foundation element 10 is connected to the connector 200 by means of a plug connection, wherein another power cable 40″ electrically connects the connector 200 to the floating wind turbine 100. The functions and tasks of the individual elements are described in detail below.

FIG. 2 shows a perspective view of a first exemplary embodiment of the foundation element 10 with a conventional universal joint with intersecting joint rotary axes (A), and a second exemplary embodiment of the foundation element with an eccentric universal joint (B). In particular, FIG. 1A shows a foundation element 10 designed as a pile foundation for the anchoring of a floating wind turbine 100 to a bed of body of water. The foundation element 10 has a conventional universal joint 20 on its upper side, which is formed from two axle stubs 22, 24 which are connected to one another by means of a spherical intermediate piece 26. In this case, the one axle stub 22 is designed to be flexurally rigid and connected to the foundation element 10 in a rotationally fixed manner, and the other axle stub 24 is configured for connection to a mooring line 30 connecting the foundation element 10 to the floating wind turbine.

In particular, the other axle stub 24 has, as a first connecting means 50, two pulleys 50 formed parallel to each other, each of which accommodates a mooring line 30 in the form of a cable guided around the pulleys 50 acting as idler pulleys. A bushing which accommodates a power cable 40′ is provided between the pulleys 50 or cables 30. The power cable 40′ is connected to the floating wind turbine and incorporates it into an electrical grid. For this purpose, the foundation element 10 specifically has a connection which is configured for connection to a power cable 40 and creates an electrical connection between the power cable 40 leading away from the foundation element 10 which is designed in particular as a submarine cable, and the power cable 40′ leading from the wind turbine to the foundation element 10.

The conventional universal joint 20 shown in FIG. 2A has a maximum bending angle of approximately 35-45°, whereas the eccentric universal joint 20 shown in FIG. 2B has a maximum bending angle of up to 90° with a cuboid intermediate piece 26.

FIG. 3 shows the connection of the mooring lines 30 connected to the foundation element to the floating wind turbine 100 in a perspective view (A) and a sectional view (B). The connection of the mooring line 30 to the underside of the floating wind turbine 100 is designed in particular as a counterpart to the foundation element 10. In particular, a connecting means 120 designed as two pulleys 120 is provided here and connects two mooring lines 30 to the wind turbine 100, wherein the second connecting means 120 is rotatably mounted relative to the wind turbine 100 by means of the slewing gear 110. The deflecting pulleys 120 are in particular fixedly connected to the slewing gear 110 via a support frame so that the loads of the floating wind turbine 100 from wind and wave are transmitted to the mooring system and thereby to the foundation element 10 on the bed of the body of water.

The slewing gear 110 has a bushing for the power cable 40′ arranged between the pulleys 120, wherein a rotary drive 140 which causes a rotation of the slewing gear 110 is provided. The rotary drive 140 is controlled by a controller which is configured with a device for detecting the rotational position of the floating wind turbine 100 in relation to the foundation element 10. In this regard, the second connecting means 120 can be selectively rotated in a controlled manner via the rotary drive 140 to prevent twisting of the connecting elements 30 and the power cable 40′ when the horizontal alignment of the floating wind turbine 100 is changed. To determine the required rotational angle which the rotary drive 140 must rotate the second connecting means 120 so that the connecting means 30 leading up to the foundation element 20 is aligned straight, i.e., without rotation, a direction sensor 150 is attached to the floating wind turbine in order to determine the rotational position of the floating wind turbine 100 around the foundation element 10. It must be taken into account that the universal joint 20 performs an uneven transmission of rotation when the latter is bent.

FIG. 4 shows the floating wind turbine 100 shown in FIG. 1 before the anchoring thereof to the bed of the body of water in an overview (A) and in a detail view in the region of the surface of the body of water (B). In particular, FIG. 4A shows a first section of a mooring line 30 fastened to the foundation element 10, the free (upper) end of which is fastened to a connector 200 designed as a buoy. In this case, the first section of the mooring line 30 has a length which corresponds at least to the depth of the body of water in the region of the foundation element 10 placed in the bed of the body of water. In any case, the buoyant connector 200 has fastening means on its underside for fastening the first section of the mooring line 30 and the power cable 40′. FIG. 4B shows a detail view of FIG. 4A in which it can be seen that the connector 200 in the shown example floats on the water's surface, and the second (upper) section of the mooring line 130 is temporarily fastened to the wind turbine 100. The floating wind turbine 100 has the second connecting means 120 to which the second section of the mooring line 130 is pre-attached and entrained so that the wind turbine 100 can be connected at the water's surface to the connector 200 and therefore indirectly to the foundation element 10.

The particularly preferably provided connector 200 is shown in more detail in FIG. 5 in a perspective view from above (A) and from below (B). The connector 200 designed as a buoy consists substantially of a floating body 210 to which additional connecting means for fastening the sections of the mooring line 30, 130 are connected. Centrally, there is a watertight junction box 220′, 220″ into which the power cables 40″, 40″ are inserted from above and below and electrically connected to each other.

FIG. 6 shows a sectional view of the particularly preferably provided connector 200 in the decoupled state (A) and in the coupled state (B). The floating body 210 is designed in particular such that it carries the weight of the first section of the mooring line 30 and the lower power cable 40′ and can hold the entire unit on the water's surface. To release the connection between the foundation element 10 on the bed of the body of water and the floating wind turbine 100, the second section of the mooring line 130 is mechanically released from the connecting buoy 200, and the electrical connection of the power cable 40″ is disconnected. For this purpose, the plugs 45″ of the three phases accommodated in the junction box 220″ are pulled out of the sockets 220″.

FIG. 7 and FIG. 8 serve to explain the geometric relationships basically represented by the system. In this regard, FIG. 7 shows a particularly configured system according to the invention in a side view in which the floating wind turbine 100 is shown in two opposite positions with respect to the alignment relative to the foundation element 10 at the bed of the body of water. It can be seen that the floating wind turbine 100 moves around the foundation element 10 depending on the wind direction, wherein the mooring line 30 and the power cable align accordingly and are held taut by the wind and wave loads. Under these movements, the mooring line 30 and the universal joint 20 on the foundation element 10 tilt spatially about the vertical axis according to the orientation. The angle between the vertical (shown dashed) and the alignment of the mooring line 30 corresponds to the bending angle ß of the second axle stub 24 of the universal joint 20.

Finally, FIG. 8A shows a particularly configured system according to the invention in a plan view, wherein a floating wind turbine 100 connected to a foundation element 10 by means of a mooring line 30 is shown in four different positions offset by 90° in each case. The floating wind turbine 100 rotates about the foundation element 10 depending on wind and waves, wherein the mooring line 30 is held taut by the wind and wave load. In addition, the submarine cable 40 connected to the wind turbine 100 can be seen, which conducts the electrical energy generated by the wind turbine 100 to the transfer station.

These four positions shown in FIG. 8A are shown in FIG. 8B in a detailed plan view of the foundation element 10. Based on the alignment of the pulleys 50, it can be seen that the second axle stub 24 of the universal joint 20, when rotated about the longitudinal axis of the first axle stub 22, simultaneously performs a rotation about its own axis so that the pulleys 50 at the positions of the second axle stub rotated by 90° to the previous position are also rotated by 90°. In so doing, the rotational position of the second axle stub 24 about the first axle stub 22 is indicated by the angle epi, wherein the rotational position of the second axle stub 24 about its own axis is given by the angle 92. In other words, the angle between the instantaneous direction of rotation of the mooring line 30 in the horizontal plane and the direction of rotation of the pivot axes of the universal joint 20 is defined as deviation angle 1, wherein the angle of rotation of the second axle stub of the universal joint of the side connected to the mooring line 30 is denoted by 92. The rotary drive 140 must rotate the second connecting means 120 by this angle 92 to prevent the mooring line 30 and the power cable 40 from twisting.

The basis is that when a conventional universal joint is angled by the bending angle ß and rotated in this state, the angle of rotation φ₂ of the output shaft deviates from the angle of rotation φ₂ of the input shaft. The following relationship applies:

$${φ}_{2} = arctan ( \frac{tan {φ}_{1}}{cos β} )$$

1. A system having:
a foundation element having a universal joint, wherein the universal joint, has a first axle stub connected to the foundation element in a rotationally fixed manner and a second axle stub which is rotatable about the longitudinal axis of the first axle stub by carrying out a rotation about its own longitudinal axis,
a floating wind turbine,
a mooring line, one end of which is connected to the foundation element by a first connector connected in a rotationally fixed manner to the second axle stub and the other end thereof is connected to the floating wind turbine a second connector rotatably mounted on the floating wind turbine, and
a controller which causes the assumption of a rotational position of the second connector rotatably mounted on the floating wind turbine in dependence on the rotational position of the floating wind turbine about the foundation element, wherein the rotational position of the second connector rotatably mounted on the floating wind turbine corresponds to the rotational position of the second axle stub about its own longitudinal axis, which corresponds geometrically to the rotational position of the floating wind turbine about the foundation element.

2. The system according to claim 1, wherein the controller is configured, taking into account the alignment of the longitudinal axis of the floating wind turbine relative to the foundation element, to cause the assumption of the rotational position of the second connector rotatably mounted on the floating wind turbine.

3. The system according to claim 2, wherein the controller has a compass for determining the alignment of the longitudinal axis of the floating wind turbine relative to the foundation element.

4. The system according to claim 1, wherein the controller has a sensor for position determination by a global satellite navigation system.

5. The system according to claim 1, wherein the controller has a rotary drive for rotating the rotatably mounted second connector.

6. The system according to claim 1, wherein the floating wind turbine has an electrical coupling for connecting to a power cable connected to an electrical grid arranged outside the wind turbine and having a first electrical plug connector connected to the power cable, and having a second electrical connector complementary to the first electrical connector and connected to an electrical grid located within the wind turbine, wherein the plug connectors are movable relative to one another for forming and disconnecting an electrical plug connection and are configured so as to be rotatable relative to one another in order to overcome the power cable connected to the first plug connector.

7. The system according to claim 1, wherein the controller has a drive holding the floating wind turbine (100) at a predetermined distance from the foundation element (10).

8. The system according to claim 1, wherein the foundation element (10) is a pile foundation, a suction bucket foundation or a heavyweight foundation.

9. The system according to claim 1, wherein the universal joint is a conventional universal joint with intersecting joint rotary axes or an eccentric universal joint.

10. The system according to claim 1, further comprising a bellows housing the universal joint.

11. The system according to claim 10, wherein the bellows has a restoring force forcing the axle stub of the universal joint into an extended arrangement.

12. The system according to claim 10, wherein the foundation element has a plug connector configured for connection to a power cable for connection to an electrical grid arranged outside the wind turbine.

13. The system according to claim 1, wherein the foundation element has a bushing accommodating a cable connected to an electrical grid arranged outside the wind turbine.

14. The system according to claim 10, wherein the universal joint has a bushing accommodating a power cable connected to an electrical grid arranged outside the wind turbine.

15. The system according to claim 14, wherein the bushing is arranged centrally in the axle stub forming the universal joint and an intermediate piece connecting the axle stubs to one another.

16. The system according to claim 14, wherein the first connector and/or the second connector is a pulley about which the mooring line is guided.

17. The system according to claim 16, further comprising another connector arranged parallel to the first connector and to the second connector and designed as a pulley around which another mooring line is guided.

18. The system according to claim 16, wherein the mooring line is designed in two parts, wherein the two sections of the mooring line are connected to one another by a connector.

19. The system according to claim 18, wherein the connector is configured as a buoyant buoy.

20. The system according to claim 18, wherein the connector has on one of its surfaces a first connection for a first power cable connecting the connector to an electrical grid arranged outside the wind turbine and, on a surface opposite this surface, a second connection for a second power cable connecting the connector to the floating wind turbine.

21. The system according to claim 18, the length of the section connecting the foundation element to the connector corresponds to at least the depth of water in the region of the foundation element.

22. The system according to claim 18, wherein the mooring line is a cable.
